(19) United States
(12) Patent Application Publication
(10) Pub. No.: US 2017/0010002 A1
(43) Pub. Date: Jan. 12, 2017

(54) HOB

(71) Applicant: E.G.O. Elektro-Geraetebau GmbH, Oberderdingen (DE)

(72) Inventors: Martin Baier, Ettlingen (DE); Wolfgang Thimm, Karlsruhe (DE); Wolfgang Wittenhagen, Bretten (DE); Lutz Ose, Sternenfels (DE)

(21) Appl. No.: 15/204,540

(22) Filed: Jul. 7, 2016

(30) Foreign Application Priority Data
Jul. 9, 2015 (DE) 10 2015 212 916.0

(51) Int. Cl. F24C 7/08; F24C 15/10; F24C 7/06; H05B 3/26; F24C 7/04

(52) U.S. Cl. CPC F24C 7/083; H05B 3/26; F24C 7/046; F24C 7/067; F24C 15/102

(57) ABSTRACT

A hob has a hob plate and a plurality of heating devices arranged beneath the hob plate, wherein the hob plate is designed such that it transmits light in the wavelength range visible to the human eye. The heating device has an electrical resistance heater arranged on a support with thermal insulation. IR-stimulable material including quantum dots is arranged as an indicator light or lighting means on the resistance heater or on the thermal insulation or on the hob plate. The IR-stimulable material is formed in such a way that it can be excited to output light for the indicator light by excitation light in the IR wavelength range.

### CROSS-REFERENCE TO RELATED APPLICATIONS

This application claims priority to German Applicant No. 10 2015 212 916.0, filed Jul. 9, 2015, the contents of which are hereby incorporated herein in its entirety by reference.

### TECHNOLOGICAL FIELD

The invention relates to a hob comprising a hob plate and comprising at least one heating device which is arranged beneath the hob plate.

### BACKGROUND

By way of example, US 20130098351 A1 and EP 2642821 B1 disclose indicators or indicator lights on hobs, which indicators or indicator lights do not operate simply only with a lighting means such as, for example, an LED which is arranged in a visible position. Materials with extraordinary properties are used here.

### BRIEF SUMMARY

The invention is based on the object of providing a hob of the kind cited in the introductory part with which problems of the prior art can be solved and it is possible, in particular, to provide an advantageous indicator light on a hob.

This object is achieved by a hob. Advantageous and preferred refinements of the invention are the subject matter of the further claims and will be explained in greater detail in the text which follows. The wording of the claims is incorporated in the content of the present application by express reference.

It is provided that the hob has a hob plate and at least one heating device which is arranged beneath the hob plate. The hob plate can advantageously be composed of hard glass or of glass ceramic, as is known per se. The hob plate can be largely transparent or of a reddish-brown color. The hob plate is advantageously designed such that it transmits light in a wavelength range which is visible to the human eye, even if this is only a low level of transmissivity. This wavelength range extends from approximately 380 nm to 780 nm. The level of transmissivity does not necessarily have to apply to the entire wavelength range which is visible to the human eye, but rather can also apply for narrow ranges or substantially individual colors. In the IR wavelength range, the hob plate can be transparent or have a transmission of more than 50%, advantageously more than 80% or even 90%. This is primarily advantageous when using radiant heating bodies or generally electrical resistance heaters which have very high temperatures and therefore a very strong IR radiation component.

The heating device operates electrically and preferably has an electrical resistance heater which is arranged on a support with thermal insulation. The resistance heater can firstly be a so-called strip-like resistance heater in the form of a radiant heater, as is known, for example, from U.S. Pat. No. 5,393,958 B1. Here, the electrical resistance heater, by way of its strip, is exposed to the atmosphere, wherein it is arranged partially on a support with a thermal insulation. This thermal insulation can advantageously be of flat or board-like or plate-like design, wherein the resistance heater or the resistance heating element rests on the thermal insulation, possibly in a partially embedded manner.

As an alternative, the heating device can have an electrical resistance heater in the form of a so-called tubular heating body, as is known, for example, from EP 2481259 B1. In this case, the actual resistance heating element is situated in a metal tube in a manner surrounded by insulating material, it being possible for the metal tube ultimately to be heated by the resistance heating element or even to be made to glow and then likewise operate as a radiant heater. In a further alternative, an electrical resistance heater can be a so-called halogen lamp, also known as a bright radiator, as can likewise be used for hobs. The alternative resistance heaters are also arranged on supports with thermal insulation in order to increase the amount of thermal radiation at the top to a cooking vessel which is placed above it on the hob plate or to improve the energy efficiency. Furthermore, heating of the hob at the bottom into an item of fitted furniture or the like should not be too excessive.

An IR-stimulable material which forms an indicator light or a lighting means is designed such that it can be excited by light in the IR wavelength range and then outputs light. Therefore, it can serve as an abovementioned indicator light or lighting means. This effect is a fluorescence and, respectively, these materials are also called anti-Stokes materials. Light in the IR wavelength range is always present during the heating operation owing to the abovementioned resistance heater and usually also for a short time after the heating operation while the resistance heater, for example after switch-off, is still hot enough or as long as it has not yet cooled to too great an extent. Owing to the use of the IR stimulable material, which can be material comprising quantum dots in particular, an indicator light or lighting means can be generated with colors other than with red to orange or orangey yellow as are emitted by customary glowing resistance heaters. IR-stimulable materials of this kind are also known from U.S. Pat. No. 4,806,772 A, the content of the document in respect of these materials also being incorporated in the content of the present application by express reference.

In this case, the IR-stimulable material is arranged on the resistance heater and/or on the thermal insulation and/or on the hob plate and/or on an additional support. The IR-stimulable material is advantageously located in the immediate region which is subjected to strong irradiation by thermal radiation by the heating device or the resistance heater. The arrangement of the IR-stimulable material on an additional support or the like, which additional support can be arranged on the heating device or primarily on the thermal insulation, may, however, mean expenditure on an additional part which is dispensed with when parts of the hob or the heating device which are present in any case are used.

This IR-stimulable material should be selected to be correspondingly temperature-stable, so that a long-term temperature stability for temperatures of greater than 1000° C. is provided. Primarily in the case of exposed electrical resistance heaters which visibly glow brightly during the heating operation, the temperatures should even be still higher, for example up to 1300° C. The abovementioned tubular heating bodies are generally not hotter than 1000° C., even when they begin to glow.

One advantage of the high temperature resistance or temperature stability of the materials, in addition to the use at high heating conductor temperatures, is also that this temperature resistance permit high-temperature production processes, such as enamelling, casting, sintering, stoving or the like for example.

The IR-stimulable material can generally be rare earth-doped. The IR-stimulable material can advantageously contain erbium or be doped with erbium. The erbium can particularly advantageously be ER³⁺. The IR-stimulable material is preferably material comprising so-called quantum dots or quantum rods. Materials of this kind, also called anti-Stokes materials, emit visible light when excited by IR-radiation or heat. Owing to the size of the constituent parts of the material, in particular of the quantum dots, the wavelength of the emitted light can be influenced within certain limits. For example, it is possible for a peak of the light emitted by the material comprising the quantum dots in the wavelength range of between 510 nm and 560 nm to be achieved by quantum dots from CAN, Hamburg, under the product name CANdots Series X Green. A further emission peak can be achieved in another wavelength range of between 640 nm and 690 nm.

The IR-stimulable material can be provided as an indicator light which can be identified from above through the hob plate, advantageously in the region or heating region of the at least one heating device. In one refinement of the invention, it is possible for the IR-stimulable material to be arranged at least partially directly above the heating device on the hob plate, preferably on the bottom face of the hob plate. Although it would be possible to apply the said IR-stimulable material to the top face of the hob plate, the mechanical loading during daily use when cooking over the long term is too high for the resistance of these IR-stimulable materials or of quantum dots. Therefore, it is considered to be advantageous when the IR-stimulable material is arranged on the bottom face of the hob plate or is applied to the bottom face of the hob plate. In this case, the IR-stimulable material is advantageously applied as a coating on the hob plate. However, at the same time, the IR-stimulable material should still be largely or even fully transmissive for IR thermal radiation of the resistance heating element to the outside.

In an alternative refinement of the invention, the IR-stimulable material can be an integral constituent part of the hob plate or can be admixed with the material of the hob plate. Therefore, the IR-stimulable material does not form a coating here, but rather is incorporated into the material of the hob plate. Furthermore, it is possible for the IR-stimulable material to be mixed into the material of the hob plate in such a way that certain shapes or symbols are formed, in particular adapted for the subsequent arrangement of the heating device on the hob. Therefore, complicated coating methods can be dispensed with.

In a further alternative refinement of the invention, the IR-stimulable material can be provided on the heating device, advantageously directly on the heating device. In this case, it can be provided, for example, directly on the abovementioned thermal insulation or on the abovementioned support since, as a result, the properties in respect of heat generation and thermal radiation at the resistance heater are lower. The temperature at an exposed resistance heater is also very high at the abovementioned temperatures of 1000° C. to 1100° C. and is therefore thermally very challenging both for the IR-stimulable material and also for the operation of the heating device. The IR-stimulable material can firstly be applied as a coating on the thermal insulation, for example on the areas or regions of the thermal insulation which can be readily identified from the outside and/or from above. A thermal insulation of this kind can be formed, for example, in accordance with U.S. Pat. No. 5,834,740 A, as is frequently used for radiant heating devices. This surface of this thermal insulation is suitable for surface-area coatings which are not overly fine or detailed.

Secondly, the IR-stimulable material can also be mixed into the material of the thermal insulation, for example into the quantum dots directly, and therefore integral production, for example in the form of pressing, can be performed. However, in this case, the requirements made of an IR-stimulable material of this kind are very high for the relatively low proportion which is then later provided on surfaces which are visible from above.

Certain areas of the thermal insulation which are directed upwards or can be particularly easily identified from above can preferably be provided with the IR-stimulable material. This can be, for example, an edge region of the support or of the thermal insulation which surrounds the resistance heater, or as an alternative a free central region.

In a yet further alternative refinement of the invention, the IR-stimulable material can also be provided directly on the heating device, specifically directly on the resistance heater. This is possible primarily when the resistance heater is an abovementioned tubular heating body of which the surface or outer shell, usually a metal tube, reaches temperatures of less than 1000° C., that is to say is less hot than an abovementioned exposed resistance heater of a radiant heating body.

In general, it is considered advantageous when regions of this kind are provided or coated with IR-stimulable material and can be easily identified from above. For example, in the case of a resistance heater in the form of a tubular heating body, coating of the tubular heating body does not need to be provided over the entire circumference, rather coating on the top face with IR-stimulable material is sufficient.

As an alternative, the IR-stimulable material can be applied to a support which is fitted on the heating device, the support corresponding to the abovementioned additional support which can advantageously be composed of metal, glass or glass ceramic. The support can be arranged between the heating device and the hob plate. In a further refinement of the invention, the support between the heating device and the hob plate can be in the form of a light guide or light channel.

In an advantageous development of the invention, a material comprising two different quantum dots or two different types of quantum dots can be provided, the quantum dots being designed to display two different colors during operation as an indicator light. The two different colors are then produced by different application at different temperatures. Therefore, not only is an indicator light or lighting means which is tripped by IR or thermal radiation possible on a hob, but rather an indicator light which is a different color depending on the temperature is also possible. This is advantageous, for example, for residual-heat indicators on a hob.

In a refinement of the invention, thermochromic material can be provided in a layer structure over the IR-stimulable material. A layer structure which is intended to be provided on the hob plate or on the bottom face of the hob plate or beneath the hob plate can be selected here. In this case, it is considered to be advantageous when the extent of the thermochromic material is approximately exactly the same as that of the IR-stimulable material beneath it, and it should at least have the same surface-area coverage. As an alternative, it is also possible for certain regions to be covered and for certain regions to be exposed, so that, when a specific temperature for this thermochromic material is exceeded, an IR-stimulable material which is situated beneath the thermochromic material first becomes visible when the thermochromic material changes color.

In order to produce a coating comprising the IR-stimulable material or comprising quantum dots, a starting material, often a powder, can be processed in a dispersion. This can, in turn, be admixed with a dispersion material such as a dye or other carrier material. This can then, in turn, be mixed in or applied as desired.

These and further features are apparent not only from the claims but also from the description and the drawings, where the individual features can in each case be realized on their own or jointly in the form of subcombinations in an embodiment of the invention and in other fields and can constitute advantageous and inherently protectable embodiments for which protection is claimed here. The subdivision of the application into individual sections and subheadings does not restrict the general validity of the statements made thereunder.

### BRIEF DESCRIPTION OF THE SEVERAL VIEWS OF THE DRAWINGS

Exemplary embodiments of the invention are schematically illustrated in the drawings and will be explained in greater detail in the text which follows. In the drawings:

FIG. 1 shows a section through a hob according to the invention comprising a radiant heating body to which IR-stimulable or quantum dot coatings are applied in different ways;

FIG. 2 shows a section through a tubular heating body as an alternative heating device;

FIG. 3 shows a schematic illustration of a multilayer coating with a thermochromic coating over a quantum dot coating;

FIG. 4 shows a plan view of the hob according to FIG. 1 with a radiant heating body illustrated using a dashed line and a lighting ring, illustrated using a dotted line, of a luminous quantum dot coating; and

FIG. 5 shows a radiation spectrum of quantum dots with two main wavelength ranges of the radiation.

### DETAILED DESCRIPTION

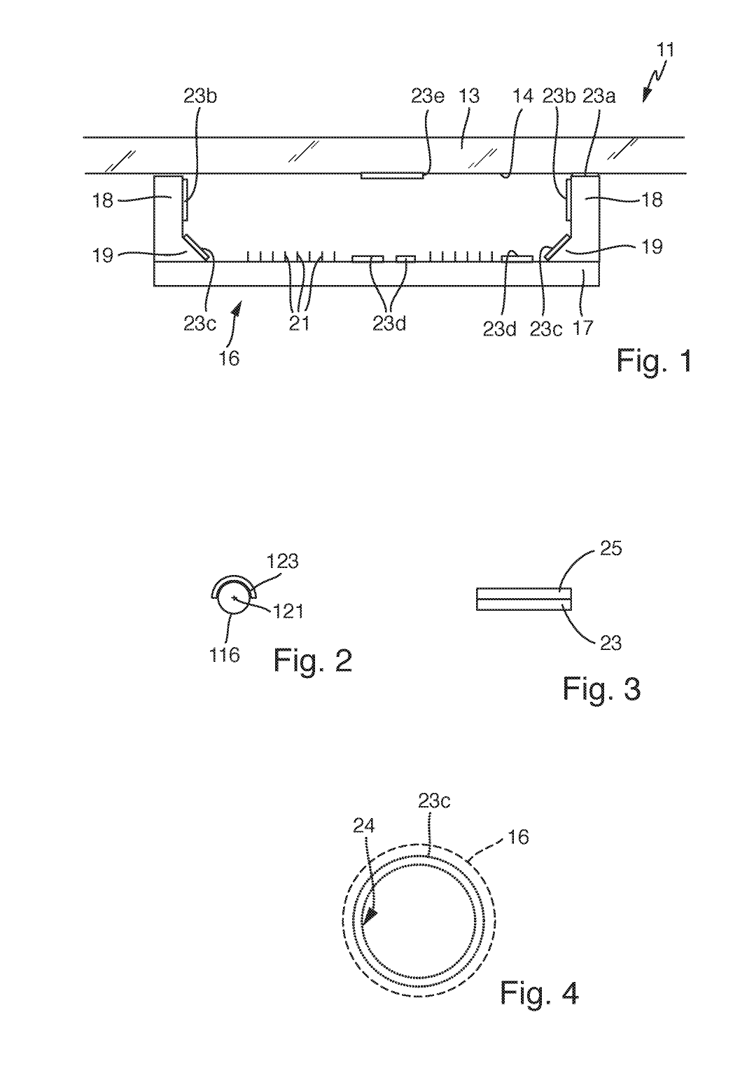

FIG. 1 shows a section through a hob 11 according to the invention which is designed largely in a conventional manner. The hob has a hob plate 13, advantageously a hob plate which is composed of glass ceramic such as, for example, KeraVision from EuroKera or Hightrans from SCHOTT. A radiant heating body 16 is pressed onto a bottom face 14 of the hob plate 13, as is customary. The hob can have a plurality of such radiant heating bodies.

The radiant heating body 16 is constructed largely in accordance with the abovementioned prior art and has a plate- or board-like support 17 which is composed of thermally insulating material. A circumferential support edge 18 is mounted or integrally formed on the outside of the radiant heating body. Under certain circumstances, the support 17 which is composed of thermally insulating material can also be held in the manner of a sheet-metal plate, but this is not important for the invention. An oblique edge fillet 19 can be provided between the support edge 18 and the support 17. A resistance heater 21 is arranged in a standing manner on the support 17. The resistance heater is in the form of an upright flat strip and runs in a spiral or meandering manner on the support 17.

A coating comprising IR-stimulable material, here comprising material comprising quantum dots, can be arranged on the radiant heating body 16 and/or the support 17 or the support edge 18 in different ways. A first possibility is a quantum dot coating 23a on the top face of the support edge 18. The quantum dot coating can extend around the entire circumference or form individual points, regions, symbols or the like. Since this quantum dot coating 23a is pressed directly onto the bottom face 14 of the hob plate 13, it is very clearly visible from above. However, at the same time, it may be possible that only a small extent of the said quantum dot coating can be reached by the IR radiation of the resistance heater 21 of the radiant heating body 16. An IR-stimulable material of this kind can either have quantum dots with erbium doping from the start or be designed in accordance with the abovementioned document U.S. Pat. No. 4,806,772 A.

A further IR-stimulable quantum dot coating 23b is provided on the inwardly facing side of the support edge 18. The further IR-stimulable quantum dot coating can also be formed entirely or largely circumferentially as a kind of ring, or as an alternative individual points or the like, as has been explained above for the quantum dot coating 23a. Although the quantum dot coating 23b on the sides of the support edge 18 is less clearly visible from above, it can be very readily irradiated by the IR radiation of the resistance heater 21.

A further IR stimulable quantum dot coating 23c is applied on the edge fillet 19 which is additionally provided for this purpose. This quantum dot coating 23c can be both identified very clearly from above and also can be readily irradiated by the IR radiation of the resistance heater 21. Coating can also be performed in different forms, as long or even continuous strips, or as an alternative as individual points, symbols or the like, here.

According to a further possibility, an IR-stimulable quantum dot coating 23d can be applied on the support 17 or the top face of the support, for example centrally, but also at the edge region. Although a particularly large surface area may not be available here under certain circumstances, both visibility and ability to irradiate are very good.

A further possibility for an IR-stimulable coating is a quantum dot coating 23e on the bottom face 14 of the hob plate 13. The quantum dot coating has the advantage that it is both very clearly visible from above and can be irradiated very readily by the IR radiation of the resistance heater 21. However, the quantum dot coating has the disadvantage that it is not applied to the radiant heating body 16 itself, but rather just to the hob plate 13. Therefore, it has to be applied in completely different working steps.

As an alternative to a coating, a foil, a glass panel or some other suitable support on which a quantum dot coating 23 is applied can be stuck on in each case.

FIG. 2 shows an alternative heating device, as could be used for an oven or else for a hob. A tubular heating body 116 has a metal tube in which a heating wire 121 runs. In addition, the tube is filled with pulverulent or granular insulating material. A tubular heating body 116 of this kind can be designed in the manner cited in the introductory part and form the abovementioned resistance heater.

An IR-stimulable quantum dot coating 123 is applied on the tubular heating body 116 at the top. The IR-stimulable quantum dot coating can cover substantially the top half, but, for example, also only a top third or a top quarter which can also be seen or can be identified as clearly as possible from above. Although the resistance heaters 21 of the radiant heating body 16 of FIG. 1 can be provided directly with a quantum dot coating, the high temperatures of the resistance heaters during heating operation of approximately 1100° C. make coating difficult. In addition, the degree of efficiency could be adversely affected.

FIG. 3 schematically shows a layer structure comprising an IR-stimulable quantum dot coating 23 on which a thermochromic coating 25 is arranged. As has been described above, the thermochromic coating 25 can change its color or even become transparent at a certain temperature. Therefore, a quantum dot coating 23 which is situated beneath the thermochromic coating becomes visible or is no longer visible at this temperature. Furthermore, the color may change owing to the thermochromic coating 25. With reference to FIG. 3, it is also easy to imagine how a layer structure with still more layers could be formed, for example even a plurality of IR-stimulable quantum dot coatings one above the other.

FIG. 4 shows a plan view of the hob 11 from FIG. 1 with lights of an IR-stimulable quantum dot coating 23c as indicator light 24 in the form of a circumferential lighting ring, illustrated using a dotted line. This indicator light 24 can be identified through the hob plate 13 and can constitute, for example, an operation indicator or heat indicator for the radiant heating body 16 or the heating operation of the radiant heating body.

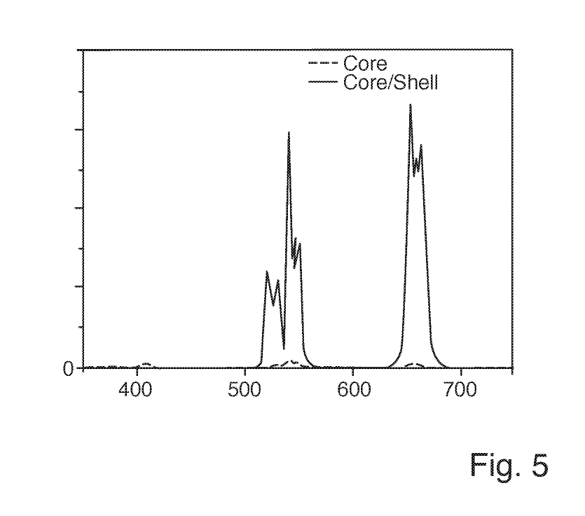

FIG. 5 shows an emission spectrum of an IR-stimulable quantum dot coating or of material comprising quantum dots. The quantum dots are quantum dots from CAN, Hamburg, with the name CANdots Series X Green. These quantum dots comprise so-called “core” particles which are composed of NaYF_{4:}Yb, Er. This is the lower curve with the very small deflections at approximately 540 nm and 650 nm. The deflections can be excited to light up by IR radiation.

Furthermore, the upper curve for quantum dots comprising so-called “core/shell” particles is shown. The core/shell particles are composed of NaYF_{4:}Yb, Er/NaYF₄. The maxima of this emission or radiation are far higher but, in principle, are found in approximately the same wavelength. The color produced is then green. The respective IR-stimulable materials comprising quantum dots are irradiated with near-field IR light with a wavelength of 980 nm, for example as is contained in the spectrum of the radiant heating body 16 or of the resistance heater 21 during heating operation.

That which is claimed:

1. A hob comprising a hob plate and comprising at least one heating device being arranged beneath said hob plate, wherein:
said hob comprises a hob plate being designed to transmit light in a wavelength range visible to a human eye;
said heating device comprises an electrical resistance heater being arranged on a support with a thermal insulation;
IR-stimulable material is provided as an indicator light or lighting means being formed in such a way that it can be excited to output light or emit light by excitation with light in an IR wavelength range; and
said IR-stimulable material is arranged on at least one of said resistance heater, said thermal insulation, said hob plate and an additional support.

2. The hob according to claim 1, wherein said IR-stimulable material has a long-term temperature stability at temperatures of greater than 1000° C. to 1300° C.

3. The hob according to claim 1, wherein said IR-stimulable material comprises erbium or is doped with erbium.

4. The hob according to claim 3, wherein said IR-stimulable material comprises Er3+.

5. The hob according to claim 1, wherein said IR-stimulable material is quantum dots or wherein it has quantum dots.

6. The hob according to claim 1, wherein said IR-stimulable material is provided as an indicator light in a region or in a heating region of the at least one heating device.

7. The hob according to claim 1, wherein said IR-stimulable material is arranged at least partially directly above said heating device on said hob plate.

8. The hob according to claim 7, wherein said IR-stimulable material is arranged at least partially directly above said heating device on a bottom face of said hob plate.

9. The hob according to claim 8, wherein said IR-stimulable material is applied as a coating in a non-removable manner onto said hob plate.

10. The hob according to claim 1, wherein said IR-stimulable material is an integral constituent part of said hob plate.

11. The hob according to claim 1, wherein said IR-stimulable material is admixed with a material of said hob plate.

12. The hob according to claim 1, wherein said IR-stimulable material is provided directly on said heating device.

13. The hob according to claim 12, wherein said IR-stimulable material is applied as a coating on said thermal insulation.

14. The hob according to claim 12, wherein said IR-stimulable material is provided directly on said resistance heater.

15. The hob according to claim 14, wherein said IR-stimulable material is applied as a coating on said resistance heater.

16. The hob according to claim 1, wherein said IR-stimulable material is applied to a support being fitted to said heating device, said support being positioned between said heating device and said hob plate.

17. The hob according to claim 16, wherein said support is in a form of a light guide.

18. The hob according to claim 16, wherein said support is made from one of the following materials: metal, glass or glass-ceramic.

19. The hob according to claim 1, wherein said IR-stimulable material is designed to display two different colors during operation as an indicator light, wherein said two different colors are produced by different application at different temperatures.

20. The hob according to claim 1, wherein thermochromic material is provided in a layer structure over said IR-stimulable material.

21. The hob according to claim 20, wherein said thermochromic material is provided on said hob plate or beneath said hob plate.

22. The hob according to claim 20, wherein said thermochromic material is provided with uniform surface-area coverage.
